(19) United States
(12) Patent Application Publication
(10) Pub. No.: US 2025/0271346 A1
(43) Pub. Date: Aug. 28, 2025

(54) OPTICAL SYSTEM FOR ENVIRONMENTAL MONITORING

(71) Applicant: The Charles Stark Draper Laboratory, Inc., Cambridge, MA (US)

(72) Inventors: Melissa Wessels, Cambridge, MA (US); Loyd Waites, Cambridge, MA (US); Ryan Gelly, Cambridge, MA (US); Stephen Sirisky, Cambridge, MA (US); Joseph Hollmann, Cambridge, MA (US); Elizabeth Wiellette, Cambridge, MA (US)

(21) Appl. No.: 19/059,762

(22) Filed: Feb. 21, 2025

Related U.S. Application Data
(60) Provisional application No. 63/556,500, filed on Feb. 22, 2024.

(51) Int. Cl. G01N 15/1429; G01N 15/1434

(52) U.S. Cl. CPC G01N 15/1429; G01N 15/1434

(57) ABSTRACT

An optical system for sensing molecular species may include an optical subsystem having a telescope configured to receive a signal corresponding to a sample, an electronics subsystem configured to sample and filter the signal, and a controller configured to analyze the signal for characteristics corresponding to a molecular species.

### CROSS-REFERENCE TO RELATED APPLICATIONS

This application is a continuation of U.S. Provisional Application No. 63/556,500 filed Feb. 22, 2024, the disclosures of which are hereby incorporated in their entirety by reference herein.

### TECHNICAL FIELD

The present disclosure relates to optical systems for environmental monitoring.

### BACKGROUND

Harmful bacteria, infectious microbes, or pathogens can cause harm to humans, animals, and plants, as well as microbes found in seawater, effect chemical sensing, etc. Such bacteria may contribute to diseases as well as other heath issues. Identification of bacterial species, including molecular species or pathogens, may depend on close contact with the bacteria to collect samples. The samples may then be characterized based on microscopic and molecular levels and may require close contact with the bacteria.

### SUMMARY

An optical system for sensing molecular species may include an optical subsystem having a telescope configured to receive a signal corresponding to a sample, an electronics subsystem configured to sample and filter the signal, and a controller configured to analyze the signal for characteristics corresponding to a molecular species.

A method for sensing molecular species including receiving user parameters at an interface, modifying contradictory parameters, receiving a signal from a detector and acquiring pulses on an analog to digital converter until a total pulse or per pixel amount is reached, instructing at least one mirror to move, instructing a laser to generate laser pulses, in response to the number of pixels being reached, analyze the signals, and display result data to user based on the analyzing, wherein the results identify a molecular species corresponding to the result data.

An optical system for sensing molecular species may include a telescope configured to receive a signal corresponding to a sample, at least one filter and converter configured to process the received signal, and a controller configured to analyze the signal for characteristics corresponding to a molecular species including to determine that a threshold level of characteristics corresponding to the molecular species is met, and identify the molecular species as a type of molecular species.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a block diagram of an example optical system.

FIG. 2 illustrates block diagram of the example optical subsystem of FIG. 1

FIG. 3 illustrates an example cross-sectional side view of a scanning confocal of the optical subsystem of FIGS. 1 and 2.

FIG. 4A illustrates the scanning confocal of FIG. 3 on a Newtonian telescope.

FIG. 4B illustrates the scanning confocal of FIG. 3 on a Cassegrainian telescope.

FIG. 5A illustrates a side view of principal planes of the optical system.

FIG. 5B illustrates a telescope and other elements of the optical system in a linear arrangement.

FIG. 6 illustrates a block diagram of the electronics subsystem of FIG. 1.

FIG. 7 illustrates a block diagram of an example process carried about by the processing subsystem of FIG. 1.

FIG. 8A illustrates an example commensurate sampling of the signals.

FIG. 8B illustrates an example incommensurate sampling of the signals.

FIG. 8C illustrates sampling over time with period re-triggering.

FIG. 9 illustrates an example chart where a higher-sampled trace is recovered by taking the set of multiple traces and reordering the samples by time modulo 1/frep.

FIG. 10 illustrates an example chart of up-sampling for a LIDAR signal collected on the system with a 2 giga samples per second (2GS/s) ADC both from a single trace and from the multi-period incommensurately sampled trace.

FIG. 11 illustrates an example chart illustrating centroiding for time-of-flight.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As explained above, molecular species include pathogenic bacteria can cause harm to humans, animals, and plants as well as seawater, effect chemical sensing, etc. Such bacteria may contribute to diseases as well as other health issues. Bacterial species are highly diverse in their cell features, as well as metabolic profiles. Further, certain species may vary based on environmental cues. These variations provide the opportunity to identify a unique fingerprint of spectral features that characterize a particular species.

It is important to identify and contain such molecular species or pathogens, but identification often requires close contact with the bacteria in order to properly classify and identify the pathogen. Known methods may include observations at the microscopic and molecular levels and may require close contact with the bacteria. Genetic testing or characterization by gene markers or whole genome sequencing may provide species characterization, but also take resources and time, as well as direct contact with the bacteria.

Disclosed herein is a system to identify bacteria at standoff distances using differentiable optical signatures, allowing for rapid identification of molecular species and pathogens without contamination of equipment or operator. The bacterial species is identified from optical features from a wide-ranging data set generated across multi-modal optical methods and a wide range of wavelengths, without assuming specific molecular components with known spectral qualities. Spectral features may also be extracted using machine learning methods. The processes and methods allow for identification of bacterial optical classifiers, which lead to pathogenic bacteria identification. Such identification can allow for response in a health crisis at both the individual and community levels.

In addition to the above, standoff sensing of molecular species in air or on surfaces is a highly desirable capability with many applications, including high-resolution (10s of um) LIDAR for remote inspection in potentially unsafe or inaccessible environments, remote environmental monitoring and classification of pollutants (greenhouse gases, algae formations, microplastics, etc.), hazard and safety assessments following industrial accidents or natural disasters, laser vibrometer at extreme distances, as well as systems that can be tailored for given sensing mode (LIDAR, fluorescence, FLIM, Raman) by choosing appropriate spectral filters.

The system disclosed herein may include a telescope with an objective lens for scanning confocal geometry. A pulsed laser source and silicon photomultiplier (SiPM) may be placed behind a 4f imaging relay with galvo mirrors in the Fourier plane. The galvo mirrors may be configured to both scan the laser source in the sample plane, and de-scan the light returning to the SiPM. A high-speed analog to digital converter (ADC) may then digitize the time-dependent return signals. The SiPM detectors may allow for single-photon sensitivity but acquires timing data faster than single-photon counting, leading to high-SNR (signal to noise ratio), time-resolved data. The processor may synchronize laser pulses with the ADC to maximize signal to output laser power and provide precise position resolution. The processor may then use multiple return pulses to achieve temporal resolution above sampling rate of ADC for high-resolution timing applications.

With sufficiently high-SNR, centroiding on return signals to extract radiation dynamics from the returning signal allows for localization in time better than instrument response function.

The use of large aperture telescopes enable large numerical apertures/small spatial resolutions even at distances several meters away from the instrument. Further, the system works in illuminated environments by reducing effect of background light at SiPM. The addition of filters into the detection path can be tailored to a specific application: laser bandpass filter for higher SNR LIDAR or vibrometer, fluorescence filter for fluorescence mapping or FLIM imaging, laser line filter for Raman mapping, among others.

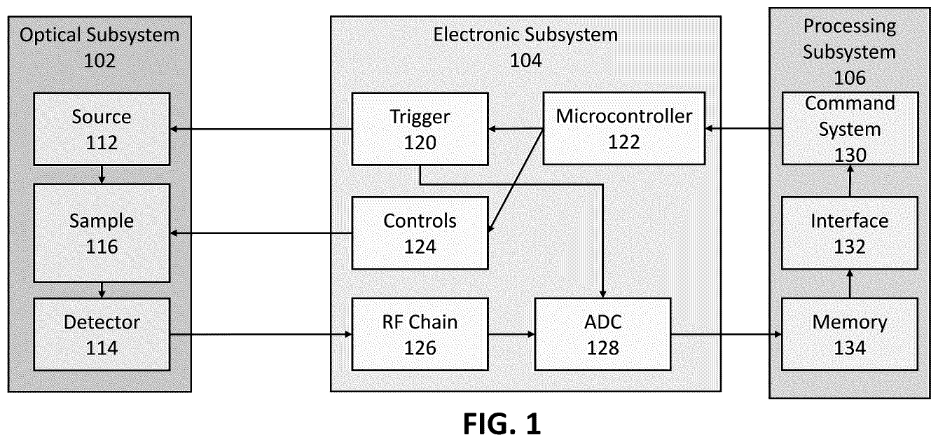

FIG. 1 illustrates a block diagram of an example optical system 100. The optical system 100 may include an optical subsystem 102, an electronic subsystem 104, and a processing subsystem 106. Each subsystem is interconnected with the others.

The optical subsystem 102 may include a source 112 and a detector 114, as well as a sample 116. The source 112 may be a light source such as a laser. The source 112 may be configured to emit light onto a sample or item to evaluate the sample.

The detector 114 may be configured to sense or measure light, as well as other electromagnetic forces. The detector 114 may be configured to convert the sensing into electrical signals. The detector 114 may include more than one detector 114 and may include various types of detectors. For example, the detector 114 may be photodiodes, phototransistors, photomultiplier tubes (PMTs), etc. In one example, the detector 114 is a silicon photomultiplier (SiMP) detector. The detector 114 may capture light to form an image, as well as allow for precise light measurements and other data processing of the sample.

The sample 116 may be a biometric sample or living organisms possibly containing bacteria, pathogens or other species. The sample may also be any target of interest having a chemical signature. The sample could include microplastics in water, as well as a sample for chemical sensing purposes. The sample 116 may be remote from the optical subsystem 102 in that direct contact with the samples may not be necessary to acquire certain sample characteristics.

The electronic subsystem 104 may include a trigger 120, microcontroller 122, controls 124, radio frequency (RF) chain 126, and analog-to-digital converter (ADC) 128. The trigger 120 may be a laser trigger 120 configured to utilize the laser beam to initiate an action when the beam is interrupted. For example, the trigger 120 may be configured to send signals to capture events cataloged by interruptions in the laser beam.

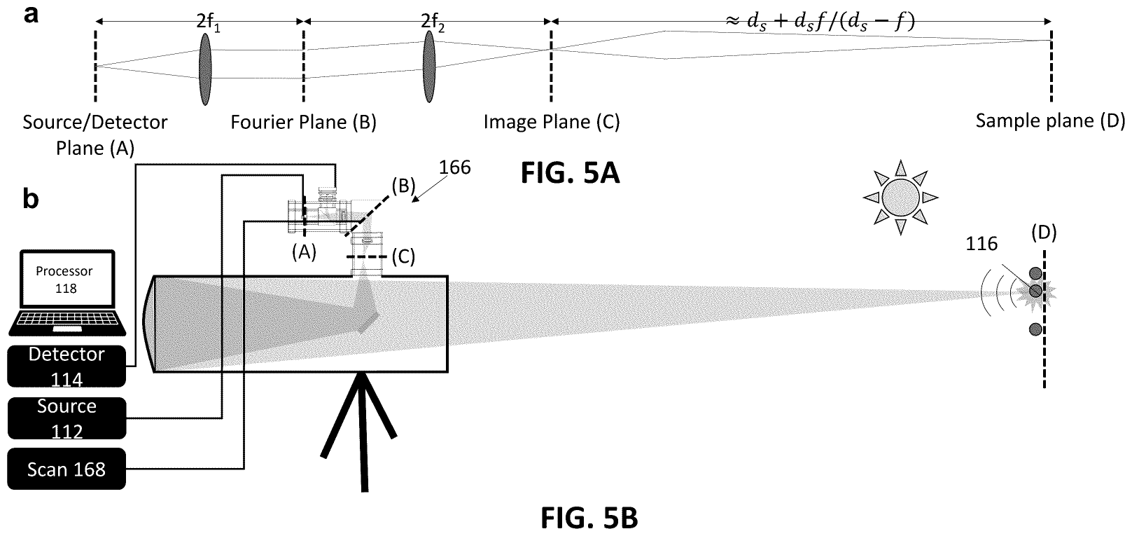

The controls 124 may include various hardware and software components configured to carry out the processes described herein. The controls 124 may be part of a processor 118 (not labeled in FIG. 1, see FIG. 5B), and interface with the microcontroller 122. The RF chain 126 may include a serious of interconnected electrical components that are configured to process RF signals. This may include transmitting, processing and receiving signals. The RF chain 126 may receive electrical signals from the detector 114 of the optical subsystem 102 prior to receipt of those signals at the ADC 128.

The processing subsystem 106 may include a command system 130, an interface 132, and a memory 134. The command system 130 may be part of a processor, including processor 118 or a separate processor. The interface 132 may be a user interface configured to both display information to a user, as well as receive user feedback. In one example, the interface 132 may be configured to receive user parameters configured to be implemented in the measuring of a sample 116 and processing of the signals received from the detector 114. For example, the user parameters may include a number of attributes such as average pulse, total pulses or pixels, frequency, number of pixels, scan dimensions, measurement types, etc. The user parameters or inputs may also receive measurement types, such as a scan, continuous capture, and signal capture.

The memory 134 may include instructions maintained in a non-volatile manner using a variety of types of computer-readable storage mediums. The memory 134 includes any non-transitory medium (e.g., a tangible medium) that participates in providing instructions or other data that may be read by the processor 118, or microcontroller 122, controls 124 and command system 130. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/structured query language (SQL).

The memory 134 may maintain certain known fingerprints comprising various spectral features of a certain pathogen, chemical, or environmental contaminant. Such features may be used to identify optical classifiers and classify the sample 116 according to its fingerprint. The memory may store known fingerprints in order to compare certain sample characteristics obtained via the imaging

The processor 118 may be programed to determine, responsive to analyzing the signal, that a threshold level of characteristics corresponding to the molecular species is met and identify the molecular species as a type of molecular species based on stored. Specifically, the temporal radiation dynamics of the received radiation over time, as well as its spectral content (which is obtained via the use of filters), pare the discriminating pieces of information of the sample. The result data is referenced against prior measurements stored in a library for classification in the memory 134, or fed into a machine learning (ML) classifier trained on such a library. For example, the threshold level of characteristics may include certain signal or wavelength thresholds, a periodicity of emissions, among other examples.

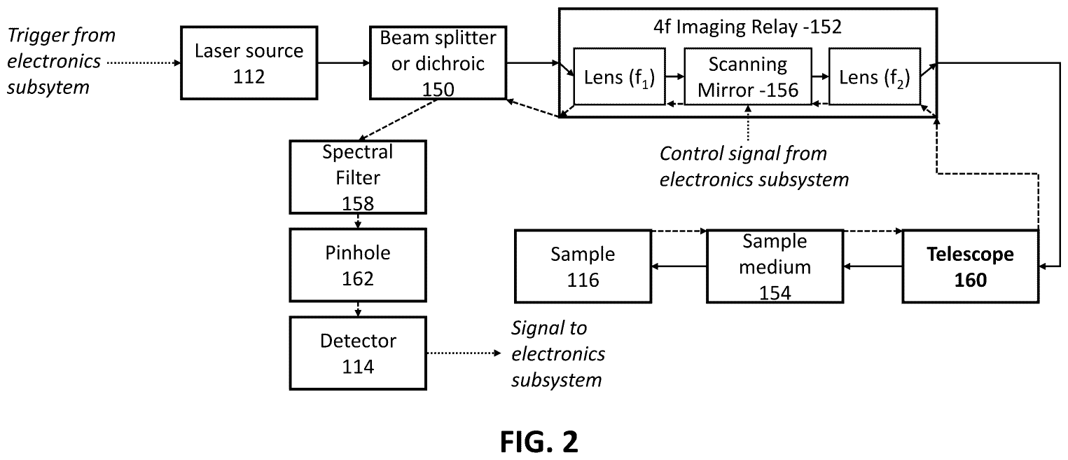

FIG. 2 illustrates block diagram of the example optical subsystem 102 of FIG. 1. The optical subsystem 102 may include the source 112, and in this example, a laser source. The source 112 may be configured to generate a beam of light to illuminate a sample. The beam may be provided to a beam splitter 150 configured to divide the beam of light into two or more separate beams. The beam splitter may be a cube or plate beam splitter. Additionally or alternatively, a dichroic filter may be applied to filter specific wavelengths of light.

The divided beam of light may be received by an imaging relay 152. The imaging relay 152 may be configured to transfer the image to a telescope 160. The imaging relay 152 may include a first lens f₁ and a second lens f₂. A scanning mirror 156 may be arranged between the lenses. The scanning mirror 156 may be configured to receive a control signal from the electronics subsystem 104. This control system may be instructions to move the mirrors in various directions in order to deflect the laser beam accordingly. The imaging relay 152 maintains the light beam's scale, orientation, resolution, etc., while transporting it a certain distance.

The telescope 160 may be a reflecting telescope such as a Newtonian telescope or Cassegrainian telescope. Other types of telescopes may be considered such as Schmidt-Cassegrain Telescopes (SCT), Gregorian telescopes, Ritchey-Chrétien telescopes, to name a few.

The telescope 160 may collect radiation from the sample 116, via the sample medium 154. The sample medium 154 may be the materials or media through which light or other electromagnetic radiation (such as infrared or radio waves) passes to reach the detector 114. For example, air or seawater.

The image of the sample 116 may return to the sample medium 154 and subsequently the telescope 160 and imaging relay 152, after incident light is scattered or re-radiated. Further, the imaging relay 152 may return the sample to the beam splitter 150, which may transmit the scattered sample to a spectral filter 158. Such return path is denoted by the dashed lines in FIG. 2. The spectral filter 158 may be configured to isolate or block certain wavelengths of light. From there the scattered beam may be received by a pinhole 162, configured to reduce the amount of light entering the system 102. The pinhole 162 may only allow light from the focal plane (the plane in focus) to pass through to the detector 114. Light from above and below the focal plane is blocked, which may reduce stray light and out-of-focus light that reduces signal contrast.

The detector 114 may receive the light after the pinhole 162 and may capture the light and convert it to a readable electronic signal. This signal may be supplied to the electronics subsystem 104, as described above with respect to FIG. 1.

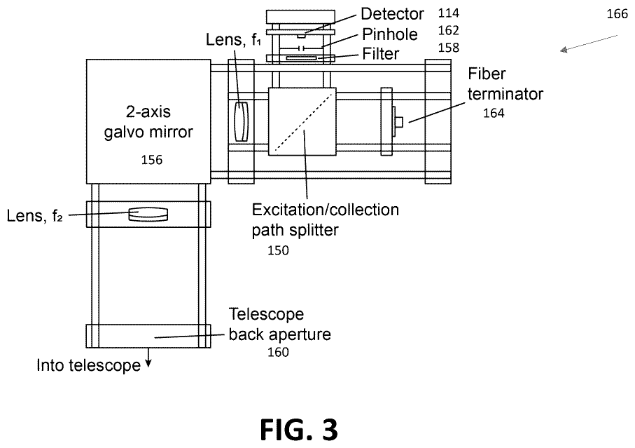

FIG. 3 illustrates an example cross-sectional side view of a scanning confocal 166 of the optical subsystem 102 of FIGS. 1 and 2. The example in FIG. 3 includes hardware components configured to implement confocal scanning. Such scanning techniques allow for capturing of high-resolution, high-contrast images of certain samples. Confocal scanning allows for sharper images, as well as three-dimensional reconstruction of samples. The laser source 112 (illustrated in FIGS. 1 and 2, but not specifically shown in FIG. 3), may be contained in a fiber connected to the system 102 via a fiber terminator 164.

The beam may then diverge via the splitter 150 before being collimated by the lens f₁. The collimated beam is directed to two-axis scanning galvanometer mirrors (i.e., scanning mirror 156). The scanning mirror 156 may be configured to adjust the angle of the collimated beam. The redirected beam is then refocused by lens f₂ at the image plane above the telescope back aperture. The beam proceeds into the telescope 160. Light returning along the same path as the excitation passes through the imaging relay 152 the opposite way and is de-scanned by the mirrors 156. The return signal is picked off by the splitter 150, passes through the spectral and spatial filter 158, and then strikes the detector 114.

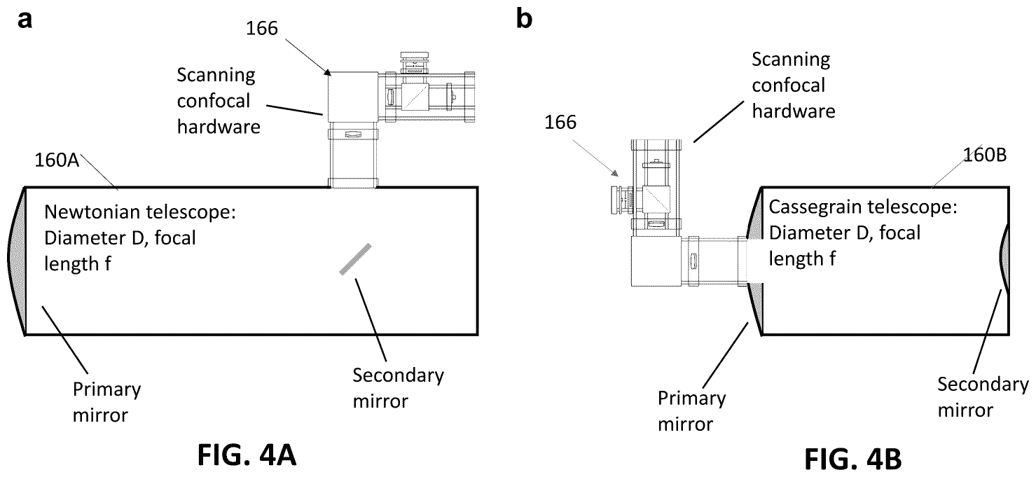

FIG. 4A illustrates the scanning confocal of FIG. 3 arranged on a Newtonian telescope 160a. FIG. 4B illustrates the scanning confocal of FIG. 3 arranged on a Cassegrainian telescope 160b. The reflecting telescopes may include mirrors and have a diameter D and focal length f. The Newtonian telescope 160a may have a longer length, a wider field of view, and lower magnification, in comparison with the Cassegrainian telescope 160b.

Other telescope configurations may be used in a given example. The aperture and focal length of the telescope may vary to address a specific application.

FIG. 5A illustrates a side view of principal planes of the optical system 102 aligned with FIG. 5B including the telescope 160 and other elements of the optical system 102 in a linear arrangement. The system may include the source 112, detector 114 and scan 168. The system may cause the source 112 to progress through various principal planes. A schematic ray trace illustrates the imaging within the system. Various lenses, mirrors, and beamsplitters between the principal planes are not pictured. FIG. 5B illustrates a use case scenario. The optical subsystem 102 is connected to the other subsystems via cables. The light source 112 is focused by the telescope 160 at the sample plane where it scatters (elastically, for LIDAR; or inelastically, for fluorescence or Raman) off surfaces or molecules (i.e. samples 116). This configuration works even when the scene is illuminated, e.g. by the sun.

Source/Detector Plane (A) (also referred to herein as “plane A”) may be taken before the first lens f₁. Fourier plane (B) (also referred to herein as “plane (B)”) may be taken at the scanning mirrors 156. Image plane (C) (also referred to herein as “plane (C)”) may be taken after the second lens f₂. The image at the laser source in plane (C) is then imaged at finite conjugation to sample plane (D) (also referred to herein as “plane (D)”). The plane (D) may be the subject or sample of the scene being illuminated. The distance between plane (A) and plane (B) may be twice the focal length of the first lens f₁. The distance between plane (B) and plane (C) may be twice the focal length of the second lens f₂ where the imaging relay operates in a 4f configuration. The distance between plane (C) and plane (D) may be ds+dsf/(ds−f) relative to the reflective optics at the mirror with a focal length f.

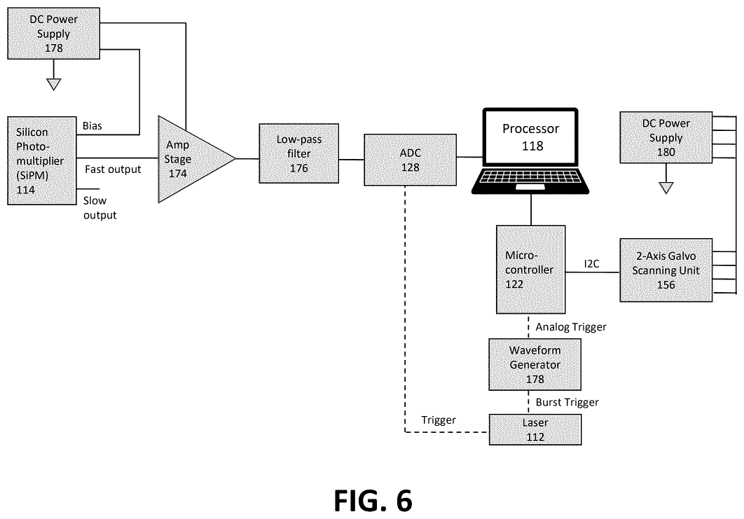

FIG. 6 illustrates a block diagram of the electronics subsystem 104 of FIG. 1. The electronics subsystem 104 may include a power supply 170, such as a DC power supply. A SiPM 172 may have a fast analog output to an amplifier 174 and a slow analog output. A low-pass filter 176 is arranged downstream of the amplifier 174 before the ADC 128. The ADC 128 may convert the analog signal from the SiPM to a digital signal for the processor 118.

The processor 118 may include the microcontroller 122 which may be in communication with at least one trigger (e.g., trigger 120), a waveform generator 178, and laser 112. The scanning mirror 156 may interface with the microcontroller 122.

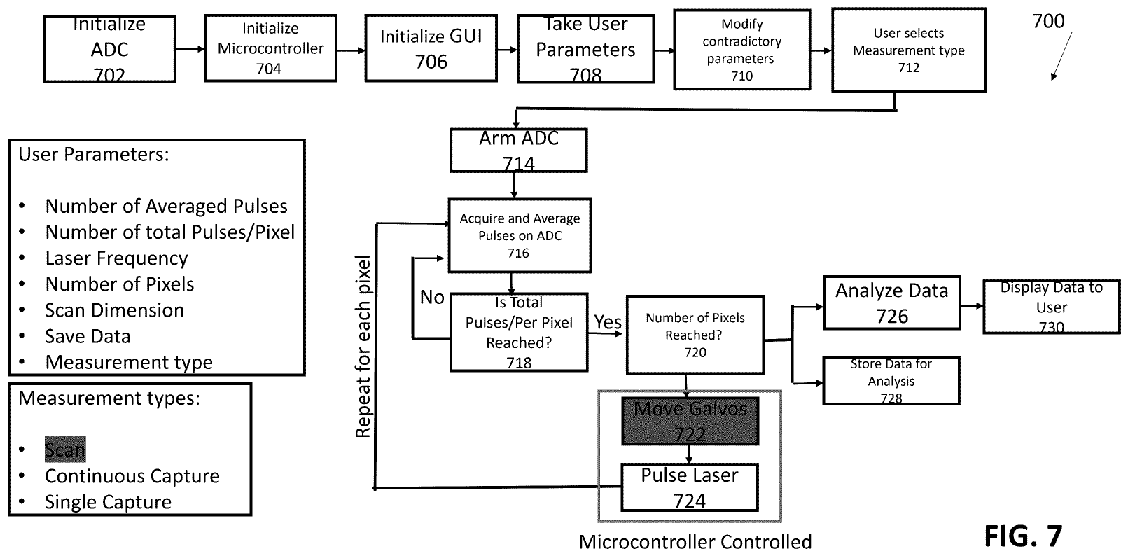

FIG. 7 illustrates a block diagram of an example process 700 carried about by the processing subsystem 106 of FIG. 1. The process 700 begins at block 702 where the processor 118 initializes the ADC 128. The processor 118 initializes the microcontroller 122 at block 704 and the interface 132 at block 706.

At block 708, the processor 118 receives user parameters. User parameters, as explained above, may include a number of attributes such as average pulse, total pulses or pixels, frequency, number of pixels, scan dimensions, measurement types, etc. Processing the user's inputs eliminates contradictions at block 710 (for example, having a scan with a square aspect ratio, but a number of evenly distributed pixels which is not a square number). The processor 118 is then able to execute a measurement selected by the user at block 712, which is either a single measurement of a single location, a scan which takes measurements over an area, or a continuous capture which takes multiple measurement of a single location over time.

Once the measurement type is selected by the user, the board is armed with these parameters and begins a measurement. At block 714, the ADC 128 converts the signal and at block 716, several traces are averaged by the ADC 128. The processor 118 repeats transferring data at block 718 until the selected number of traces is reached at block 720. At which time the microcontroller 122 is instructed to move the galvos at block 722 (if a scan was selected) and execute a burst of laser pulses at block 724. This process is repeated for the designated number of pixels given by the user at block 708.

When the number of pixels is reached the data is saved based on user input at block 728. The data is plotted and reshaped into an image showing the locations of the scan at block 726. This data is displayed to the user through the interface 132 at block 730.

While the process 700 is described as being carried out by the processor 118, all or portions of the process 700 may be carried out by the microcontroller 122, or other processors or controllers internal or external to the system 100.

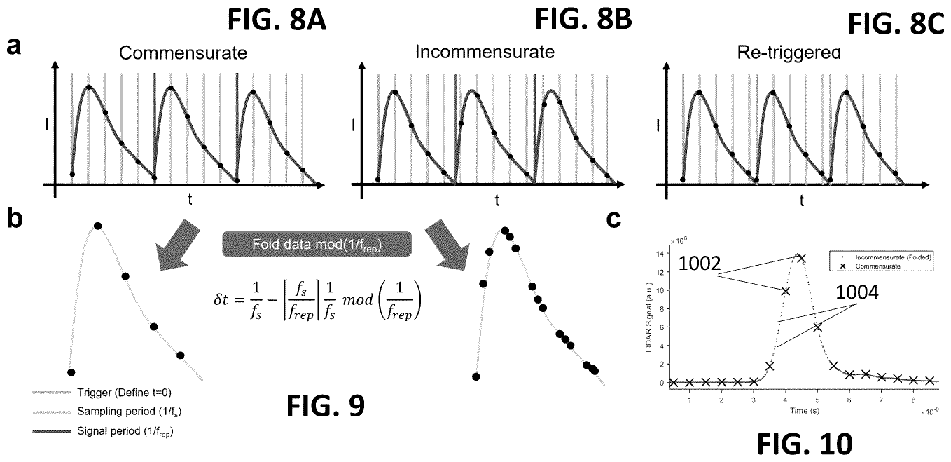

FIGS. 8A-C illustrate example charts illustrating samplings of the system 100. The sampling may illustrate a lidar signal over time (t). These are time-periodic electrical signals corresponding to the intensity of returning radiation to the detector. FIG. 8A illustrates an example commensurate sampling of the signals while FIG. 8B illustrates an example incommensurate sampling of the signals. FIG. 8C illustrates sampling over time with period re-triggering. These charts show the process for increasing the effective sampling rate of the system, beyond the sampling rate of the analog-to-digital converter (ADC). By selecting an ADC sampling rate and laser repetition period which are not integer multiples, when multiple periods are collected without re-triggering the ADC, samples between the single-period samples are collected.

FIG. 9 illustrates an example chart where a higher-sampled trace is recovered by taking the set of multiple traces and reordering the samples by time modulo 1/frep. In this example:

$$δ t = \frac{1}{{f}_{s}} - ⌈ \frac{{f}_{s}}{{f}_{rep}} ⌉ \frac{1}{{f}_{s}} mod ( \frac{1}{{f}_{rep}} )$$

FIG. 10 illustrates an example chart of up-sampling for a LIDAR signal collected on the system with a 2 GS/s ADC both from a single trace 1002 at 0.5 ns and from the multi-period incommensurately sampled trace 1004 as 25 ps mean spacing.

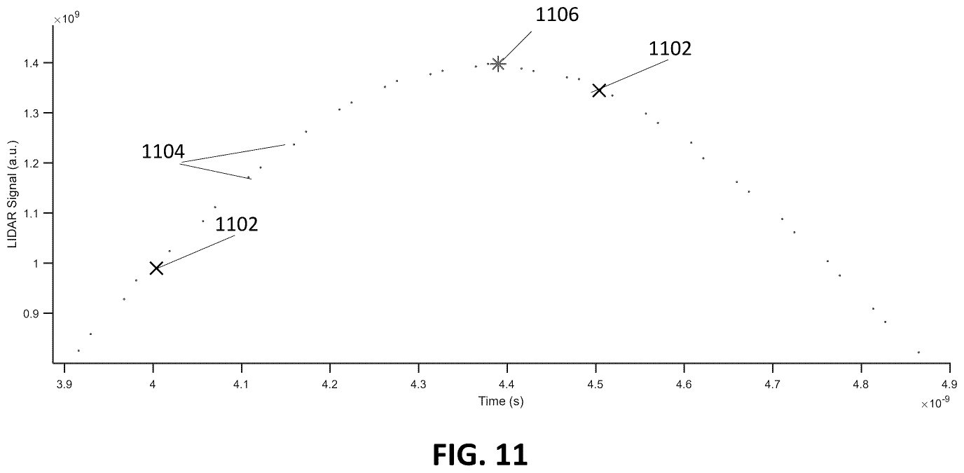

FIG. 11 illustrates an example chart illustrating centroiding for time-of-flight. Centroiding is a technique used to determine the center of an object or pattern of light within an image. The technique typically includes calculating a weighted average of pixel intensities. In the examples herein, when fluorescence lifetime is being used as the discriminator, centroiding and upsampling may allow for a higher resolution probing of time dynamics than would be possible without upsampling and centroiding.

In the current example, the axial resolution of a LIDAR system based on time-of-flight is given by cΔt/2 where Δt is the smallest difference in time-of-arrival while using the time of peak signal straight from the ADC limits resolution by the sampling rate. For a sampling rate of 2 GS/s ADC, this is Δt=0.5 ns for a resolution of 15 cm. Up-sampling can improve this resolution. For example, a 2 GS/s ADC and a 22 MHz rep-rate source, a 7.5 mm precise time-of-arrival measurements is achieved. If instead, centroiding is performed on the time series, then the signal is localized in time more precisely, depending on the SNR of the return signal. The chart illustrated in FIG. 11 indicates ADC samples 1102, up-samples by incommensurate sampling 1104, and the centroid 1106.

The systems and processes disclosed herein may be controlled by a controller or processor. The controller may include the machine controller and any additional controllers provided for controlling any of the components of the system. Many known types of controllers can be used for the controller. It is contemplated that the controller is a microprocessor-based controller that implements control software and sends/receives one or more electrical signals to/from each of the various working components to implement the control software. The controller may also include or be coupled to a memory configured to include instructions and databases to carry out the systems and processes disclosed herein.

It will be appreciated that the system and methods described herein have broad applications. The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An optical system for sensing molecular species, comprising:
an optical subsystem having a telescope configured to receive a signal corresponding to a sample;
an electronics subsystem configured to sample and filter the signal; and
a controller configured to analyze the signal for characteristics corresponding to a molecular species.

2. The system of claim 1, wherein the controller is configured to:
determine, responsive to analyzing the signal, that a threshold level of characteristics corresponding to the molecular species is met; and
identify the molecular species as a type of molecular species.

3. The system of claim 1, wherein the optical subsystem includes a scanning confocal arranged on the telescope to receive the signal corresponding to the sample.

4. The system of claim 1, wherein the optical subsystem includes a scanning confocal arranged on the telescope to receive the signal corresponding to the sample and the scanning confocal includes an imaging relay having a pair of lenses and at least one mirror, wherein the at least one mirror is configured to scan the received signal and de-scan a retuning signal.

5. The system of claim 1, wherein the optical subsystem includes a detector configured to sense light.

6. The system of claim 1, wherein the optical subsystem includes a silicon photomultiplier (SiPM) for single photon detection.

7. The system of claim 1, wherein the controller is further configured to synchronize laser pulses from a laser to produce high-resolution timing signals from the received signal.

8. The system of claim 6, wherein the controller is further configured to instruct centroiding on a return signal to extract radiation dynamics from the return signal.

9. The system of claim 7, wherein the radiation dynamics includes the characteristics corresponding to the molecular species.

10. A method for sensing molecular species, comprising:
receiving user parameters at an interface;
modifying contradictory parameters;
receiving a signal from a detector and acquiring pulses on an analog to digital converter until a total pulse or per pixel amount is reached;
instructing at least one mirror to move;
instructing a laser to generate laser pulses;
in response to the number of pixels being reached, analyze the signals; and
display result data to user based on the analyzing, wherein the results identify a molecular species corresponding to the result data.

11. The method of claim 10, further comprising,
determining, responsive to analyzing the signal, that a threshold level of characteristics corresponding to the molecular species is met; and
identify the molecular species as a type of molecular species.

12. The method of claim 10, further comprising receiving the signal at a scanning confocal.

13. The method of claim 10, further comprising scanning the received signal at the at least one mirror and descanning a return signal at the at least one mirror.

14. The method of claim 10, wherein the laser pulses are synchronized to produce high-resolution timing signals from the received signal.

15. The method of claim 10, further comprising centroiding a return signal to extract radiation dynamics from the return signal.

16. The method of claim 10, wherein the result data includes radiation dynamics corresponding to the molecular species.

17. An optical system for sensing molecular species, comprising:
a telescope configured to receive a signal corresponding to a sample;
at least one filter and converter configured to process the received signal; and
a controller configured to analyze the signal for characteristics corresponding to a molecular species including to
determine that a threshold level of characteristics corresponding to the molecular species is met; and
identify the molecular species as a type of molecular species.

18. The system of claim 17, further comprising a scanning confocal arranged on the telescope to receive the signal corresponding to the sample.

19. The system of claim 17, further comprising a silicon photomultiplier (SiPM) for single photon detection.

20. The system of claim 17, wherein the controller is further configured to synchronize laser pulses from a laser to produce high-resolution timing signals from the received signal.
